(19) United States
(12) Patent Application Publication
(10) Pub. No.: US 2009/0187123 A1
(43) Pub. Date: Jul. 23, 2009

(54) CARDIOPULMONARY RESUSCITATION UNIT CONTROL APPARATUS

(76) Inventors: Sung-Oh Hwang, Gangwon-do (KR); Won-Chul Kim, Gyeonggi-do (KR)

Correspondence Address: DICKSTEIN SHAPIRO LLP, 1825 EYE STREET NW, Washington, DC, 20006-5403, US

(21) Appl. No.: 12/298,255

(22) PCT Filed: Oct. 2, 2006
(86) PCT No.: PCT/KR2006/003957

§ 371 Date: Oct. 23, 2008

(30) Foreign Application Priority Data
Apr. 25, 2006 (KR) 10-2006-0037306

(51) Int. Cl. A61H 31/02

(52) U.S. Cl. 601/41

(57) ABSTRACT

The present invention relates to a controller for a cardiopulmonary resuscitation apparatus. Automation and precise control can be realized in the cardiopulmonary resuscitation apparatus by using a driving unit involving in constricting the chest band of the cardiopulmonary resuscitation apparatus, locking, and pressing the chest by air pressure, and a control unit controlling the driving unit according to a control signal. Further, air pressure used in driving the cardiopulmonary resuscitation apparatus is controlled so as to be also supplied to a line of artificial respiration, such that a simple construction of the cardiopulmonary resuscitation apparatus and automation of artificial respiration are obtained. Thanks to the present invention, the operator does not have to care about the operation of the cardiopulmonary resuscitation apparatus while performing cardiopulmonary resuscitation, which allows the operator pay more attention to taking care of a patient.

### TECHNICAL FIELD

The present invention relates to a controller for a cardiopulmonary resuscitation (CPR) apparatus, more particularly, to a controller for a cardiopulmonary resuscitation apparatus capable of precisely controlling a CPR apparatus by automation.

### BACKGROUND ART

Generally, the method of cardiopulmonary resuscitation provides oxygenated blood flow to the entire body of a patient whose heartbeat has stopped, in lieu of heart and lung, which involves external chest pressure and artificial respiration.

In order to restore spontaneous blood circulation, coronary perfusion pressure needs to be maintained above 20 mmHg during cardiopulmonary resuscitation. However, standard CPR can usually generate only 15-20% of normal cardiac output, which is inadequate to restore spontaneous circulation in the majority of patients. Therefore, a variety of CPR apparatuses have been disclosed to enhance the amount of blood flow.

Examples of the CPR apparatuses were filed by the present applicant and registered as Korean Patent No. 270596, Korean Patent No. 413009, and Korean Patent No. 448449.

The aforementioned Korean Patent No. 270596 is a CPR apparatus provided with a chest band that simultaneously functions as a cardiac pump for pressing the sternum and as a thoracic pump for constricting the thorax, thereby supplying a large amount of blood flow. The aforementioned Korean Patent No. 413009 and Korean Patent No. 448449 are CPR apparatuses additionally provided with length adjusting means for adjusting the length of the chest band according to the size of the patient's chest.

### DISCLOSURE OF INVENTION

### Technical Problem

However, there is a problem in the related arts in which the CPR apparatuses are inconvenient in using and inappropriate for a precise operation due to its power supply means in which a piston is reciprocally moved by manual operation and a manually operated structure of controlling the pressed depth of the piston and the length of the thoracic constriction band.

The present invention has been finalized in light of the drawbacks inherent in the related art, and it is an object of the present invention to provide a controller for a cardiopulmonary resuscitation apparatus capable of precisely controlling a CPR apparatus by automation.

### Technical Solution

In order to achieve the above object, the present invention provides a controller for a cardiopulmonary resuscitation apparatus, and the cardiopulmonary resuscitation apparatus presses the chest by a piston motion of a pressure pad. The controller includes: a pressure cylinder causing a piston motion to the pressure pad by compressed air, a control unit generating a control signal for operating the pressure cylinder, and a valve means supplying compressed air to the pressure cylinder by the control signal output from the control unit.

According to an aspect of the invention, the pressure cylinder is a double acting pneumatic cylinder using the force of compressed air input from forward and backward directions to move reciprocally.

According to another aspect of the invention, the valve means includes: an electric valve operating according to a control signal of the control unit and changing the direction of compressed air so as to supply the compressed air, a forward air pressure valve to be opened/closed by compressed air supplied by the electric valve in one direction and forwardly supplying the compressed air to the pressure cylinder while the air pressure valve is opened, and a backward air pressure valve to be opened/closed by compressed air supplied by the electric valve in the other direction and backwardly supplying the compressed air to the pressure cylinder while the air pressure valve is opened.

According to another aspect of the invention, the controller further includes: a pressed depth control unit controlling the flow velocity of compressed air that is forwardly supplied to the pressure cylinder according to a control signal of the control unit. The pressed depth control unit includes: a flow velocity control valve controlling the flow velocity of compressed air when a knob is turned; and an electric motor rotating according to a control signal of the control unit and turning the knob of the flow velocity control valve.

According to another aspect of the invention, the controller includes: an electric valve operating according to a control signal of the control unit and supplying compressed air to an artificial respiration equipment, and a breathing amount control unit controlling the amount of compressed air that is supplied to the artificial respiration.

### ADVANTAGEOUS EFFECTS

According to the aspects of the invention, automation and precise control can be realized in the cardiopulmonary resuscitation apparatus by using a driving unit for constricting the chest band of the cardiopulmonary resuscitation apparatus, locking, and pressing the chest by air pressure, and a control unit for controlling the driving unit according to a control signal.

Further, the air pressure used in driving the cardiopulmonary resuscitation apparatus is controlled so as to be also supplied to a line of artificial respiration, such that a simple construction of the cardiopulmonary resuscitation apparatus and automation of artificial respiration are obtained.

Further, it is possible to automatically perform chest pressure and artificial respiration corresponding to a predetermined number, by the control of the control unit.

In addition, if an operator selects a pressed depth, the control unit can precisely perform automatic control a descent depth of a pressure pad pressing the chest.

Thanks to the present invention, the operator does not have to care about the operation of the cardiopulmonary resuscitation apparatus while performing cardiopulmonary resuscitation, which allows the operator to pay more attention in taking care of a patient.

### BRIEF DESCRIPTION OF THE DRAWINGS

FIG. 1 is a longitudinal cross-section view of a cardiopulmonary resuscitation apparatus according to the present invention;

FIG. 2 is a transverse cross-section view of FIG. 1;

FIG. 3 is a schematic block diagram of a controller of a cardiopulmonary resuscitation apparatus according to a preferred embodiment of the invention;

FIG. 4 is a view illustrating a construction of a driving unit of FIG. 3;

FIG. 5 is a perspective view illustrating a pressed depth controlling unit of FIG. 3; and

FIG. 6 is an exemplary view when chest pressure and artificial respiration are simultaneously performed.

### MODE FOR THE INVENTION

Hereinafter, a preferred embodiment of the invention will be described in detail with reference to the accompanying drawings.

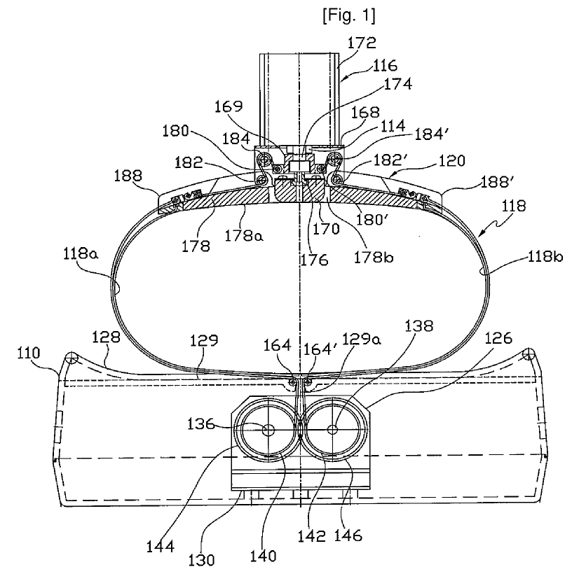

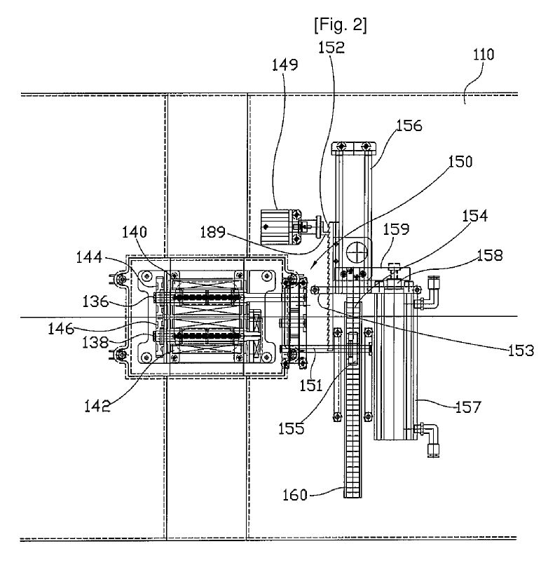

FIG. 1 is a longitudinal cross-section view of a cardiopulmonary resuscitation apparatus according to the present invention, and FIG. 2 is a transverse cross-section view of the cardiopulmonary resuscitation apparatus according to the present invention.

As shown in FIGS. 1 and 2, the cardiopulmonary resuscitation apparatus according to the invention includes a main body 110 where a patient lies, a first pressure unit 116 having a piston 114 that presses the patient's chest, a second pressure unit 120 that is coupled with the first pressure unit 116 and has a chest band 118 for wrapping around the patient's chest, and a length adjusting unit 126 in the main body 110, for controlling the length of the chest band 118 according to the size of the patient's chest.

The chest band 118 is divided into left and right chest bands 118a and 118b for respectively wrapping around the left and right chests of the patient.

The upper external surface of the main body 110 has a support side 128 which the left and right sides protrudes and is shaped with a lengthwise opening to hold around the patient when the patient is lying down. A recess unit 129 is formed on the support side 128. The long hole 129a is formed in the recess unit 129, and the lower ends of the left and right chest bands 118a and 118b are inserted into the main body 110 and wound onto the left and right bobbins 140 and 142 which will be described after.

In the support side 128, guide rollers 164 and 164′ are coupled around the long hole 129a for guiding the left and right chest bands 118a and 118b.

In the first pressure unit 116, a pressure pad 170 is coupled with the piston 114 protruded down from a support bracket 168 via a connection bracket 169 to be described later. The piston 114 is embedded in a pressure cylinder 172 and operated by air pressure. For example, the pressure pad 170 may be directly coupled with the piston 114.

Here, the pressure cylinder 172 is a pneumatic cylinder that uses force which is input from one side by air pressure to move in a forward direction, and uses force which is input from the other side by air pressure to move in a backward direction. The pressure cylinder 172 has an additional return spring therein so as to rapidly return to the initial position in the backward direction.

The connection bracket 169 is fixed at the cross-section of the piston 114 by a bolt 174, and a hitching block 176 which will be inserted and hitched to the pressure pad 170 is fixed on the lower surface of the connection bracket 169.

In the second pressure unit 120 has a protection pad 178 to be tightly attached to the patient's chest as a plurality of rollers for guiding the chest band 118 are connected to the connection bracket 169 and the support brackets 168 and the chest band 118 is fastened.

The plurality of rollers includes fixation rollers 180 and 180′ connected to the both sides of the connection bracket 169 for fixation of the left and right chest bands 118a and 118b, guide rollers 182 and 182′ connected to the both sides of the support bracket 168 for guiding the left and right chest bands 118a and 118b and fastening the protection pad 178, and idle rollers 184 and 184′ mounted between the guide rollers 118a and 118b, and the fixation rollers 180 and 180′.

The protection pad 178 includes a curved bottom surface 178a having a predetermined degree of curvature around a patient's chest and a hole 178b in the middle for passage of the connection bracket 169 and the pressure pad 170. In addition, auxiliary pads 188 and 188′ are respectively inserted at the upper side of the protection pad.

It is preferable that the protection pad 178 and auxiliary pads 188 and 188′ are made of soft material, such as, rubber, urethane or the like.

The length adjusting unit 126 includes a bracket 130 inside the main body 110, left and right axle members 136 and 138 at the bracket 130, left and right bobbins 140 and 142 fitted with the left and right axle members 136 and 138 to get the left and right chest bands 118a and 118b wound therearound, and spur gears 144 and 146 fixed at the left and right axle members 136 and 138 and meshed with each other.

As shown in FIG. 2, the driving means applying a driving force to the length adjusting unit 126 includes a chest band constricting cylinder 157 for generating a driving force as to drive the bobbins 140 and 142, a moving body 154 having a rack gear 152 that is fixed at a piston load 158 of the chest band constricting cylinder 157 and reciprocally moves in accordance with the operation of the chest band constricting cylinder 157, a guide member 156 for guiding the moving body 154, and a power transmission unit 150 that is coupled with a rotation axle 151 of the pinion 155 to transmit the rotational force to the bobbins 140 and 142.

In addition, the driving means includes a locking ratchet 152 fixed to the moving body 154, and a locking cylinder 149 that has a locker 189 meshed with the locking ratchet 152 to lock the moving body 154 and is fixed to a fixation plate 153.

The piston load 158 of the chest band constricting cylinder 157 is connected to a head part of the moving body 154 by a connecting member 159. The head part of the moving body 154 is inserted into the guide member 156 so as to slide.

Here, the locking cylinder 149 and the chest band constricting cylinder 157 are double acting pneumatic cylinders that uses force which is input from one side by air pressure to move in a forward direction, and use force which is input from the other side by air pressure to move in a backward direction.

The power transmission unit 150 is constructed with many gears meshed with one another, and transmits the rotational force of the pinion 155 to the bobbin 140 through the left axle member 136. Because the left and right bobbins 140 and 142 are directly connected to spur gears 144 and 146, respectively, if the left bobbin 140 as the rotational force of the pinion 155 enables the left bobbin 140 to rotate, the right bobbin accordingly rotates in conjunction with the left bobbin 140.

The locking ratchet 152 is a member that is fixed to the head part of the moving body 154 and has teeth continuously formed in the lengthwise direction of the moving body 154.

Next, a controller for the cardiopulmonary resuscitation apparatus having the above-described construction according to a preferred embodiment of the invention will be described.

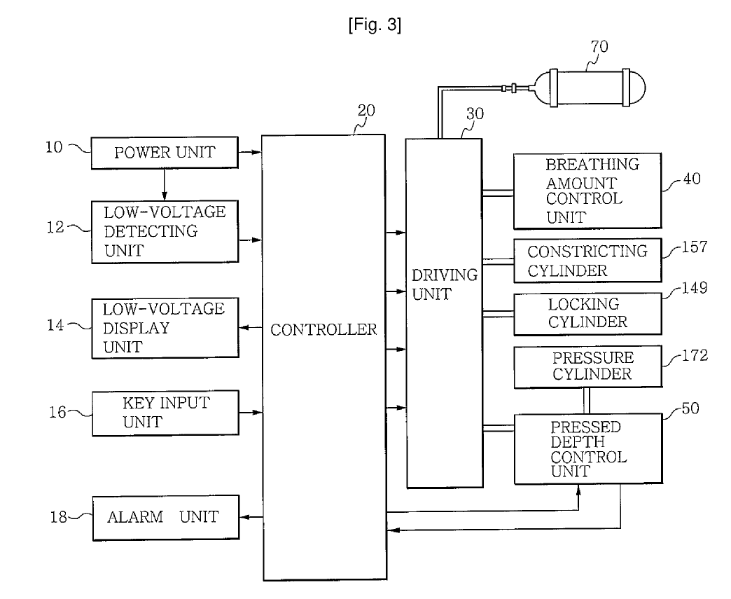

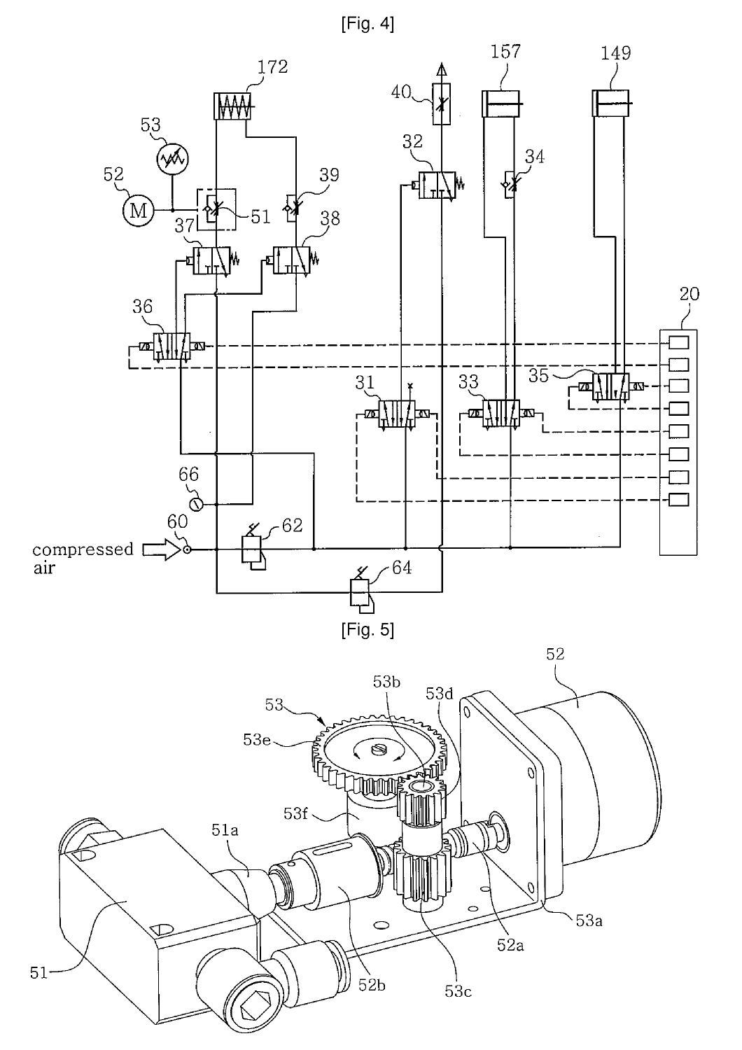

As shown in FIGS. 3 and 4, the controller for a cardiopulmonary resuscitation apparatus according to the preferred embodiment of the invention includes a power unit 10, a low-voltage detecting unit 12, a low-voltage display unit 14, key input unit 16, an alarm unit 18, a control unit 20, a driving unit 30, a breathing amount control unit 40, a pressed depth control unit 50, and a compressed air supply source 70.

The power unit 10 supplies power to each of the power consuming devices of the cardiopulmonary resuscitation apparatus and the controller. For example, the power unit 10 includes a rechargeable battery, a rechargeable adapter or the like, to stably supply power to the cardiopulmonary resuscitation apparatus in case that power is not supplied, for example, without plug-in or in blackout. Further, the power unit 10 includes a plug to be connected to a cigar jack of a vehicle, as to receive and consume a battery power or an accumulated power provided from an ambulance or the like.

The low-voltage detecting unit 12 detects a voltage level that is supplied to the cardiopulmonary resuscitation apparatus and the controller from the power unit 10, and compares the voltage level with a predetermined voltage level. If the voltage level is less than the predetermined voltage level, the low-voltage detecting unit 12 inputs a signal corresponding to the voltage level to the control unit 20. When a low voltage of the power unit is detected, the low-voltage display unit 14 displays the status of low-voltage according to a control signal output from the control unit 20. For example, the low-voltage display unit 14 may be formed of a light emitting diode or a lamp or the like.

The key input unit 16 includes various kinds of operation buttons for allowing a user to command various operations to the cardiopulmonary resuscitation apparatus and sending corresponding signals to the control unit 20 according to the button operations; the buttons include a button for fastening and loosening the chest band 118, a button for selecting operation modes of the cardiopulmonary resuscitation apparatus, and a button for selecting the pressed depth of the chest.

For example, the key input unit 16 may be a remote controller for user's convenience.

The alarm unit 18 helps the user when the user determines the pressed depth using the key input unit 16. When the pressed depth determined by the user reaches the maximum pressed depth, the alarm unit 18 alarms in accordance with control signals generated by the control unit 20. For example, the alarm unit 18 may be a buzzer.

The control unit 20 controls the display operation of the low-voltage display unit 14 and the alarm operation of the alarm unit 18, and outputs a control signal for fastening and loosening the chest band 118, a control signal for pressing the chest, a control signal for locking or unlocking the chest band 118, and a control signal for controlling the pressed depth to the driving unit 30, according to signals input by the key input unit 16.

As shown in FIG. 4, the driving unit 30 includes solenoid valves 31, 33, 35, and 36, air pressure valves 32, 37, and 38, flow velocity control valves 34 and 39, a flow path through which compressed air indicated by solid lines passes, an inlet 60 through which the compressed air supply source 70 supplies the compressed air, a pressure controller 62 and 64 for manually controlling the pressure of the compressed air that is introduced into the flow path by the inlet 60, and an outlet 66 through which the air inside the flow path is discharged to the outside.

The solenoid valves 31, 33, 35 and 36 are for direction control which operate according to control signals of the control unit 20 and change the direction of the flow path. For example, the valves may include a five port two position type solenoid valve.

The air pressure valves 32, 37, and 38 are pilot type air pressure valves, in which a pilot is operated by air pressure supplied by solenoid valve 31 and 36 to open and close the flow path.

The flow velocity control valves 34 and 39 manually control the flow velocity of the compressed air supplied to the breathing amount control unit 40, and the flow velocity of the compressed air supplied to the pressure cylinder 172 in such a direction that returns the pressure cylinder 172 to the initial position in the backward direction.

The breathing amount control unit 40 includes a flow amount control valve that supplies the compressed air supplied by the air pressure valve 32 to a known artificial respiration equipment (not shown), and manually controls the amount of air to keep the amount of breathing according to the patient's physique.

The pressed depth control unit 50 controls the flow velocity of the compressed air supplied to the pressure cylinder 172 in such a direction that advances the pressure cylinder 172, corresponding to control signals of the control unit 20, thus controlling the advanced distance, that is, the pressed depth of the piston 114.

For reference, when cardiopulmonary resuscitation is performed, the control unit 20 allows the pressure cylinder 172 to reciprocally move in the forward and backward direction for a predetermined period. The velocity of the forward movement of the pressure cylinder 172 can be changed by controlling the flow velocity of the compressed air that is supplied during the period for which the pressure cylinder 172 moves forward, whereby the control unit 20 can controls the advanced distance. For example, if the velocity of the forward moving of the pressure cylinder 172 decreases because of the change of the flow velocity, the advanced distance during the period of forward moving decreases, thus decreasing the pressed depth of the piston 114.

As specifically shown in FIG. 5, the pressed depth control unit 50 includes the flow velocity control valve 51, an electric motor 52, and a position sensor 53.

The flow velocity control valve 51 has a knob 51a at one side, and controls the flow velocity of the compressed air that is supplied to the pressure cylinder 172 when the knob 51a is turned.

The electric motor 52 is designed to rotate according to control signals from the control unit 20 so as to turn the knob 51a of the flow velocity control valve 51. The electric motor 52 includes rotation axle 52a having worm gears on its periphery and a coupling member 52b coupling the rotation axle 52a with the knob 51a of the flow velocity control valve 51.

For example, the electric motor 52 may be a stepping motor that is driven by pulse signals.

The position sensor 53 includes an L-shaped bracket 53a having an electric motor L at one side, an axel member 53b that is rotatably fixed to the bracket 53a, a worm wheel 53c that is coupled with the periphery of the axel member 53b and toothed with the worm gear of the rotation axle 52a of the electric motor, and a first spur gear 53d coupled with an upper end of the axel member 53b.

The position sensor 53 includes a second spur gear 53e that is disposed at one side of the axel member 53b and toothed with the first spur gear 53d, and a volume resistor 53f that is connected to the second spur gear 53e and has a variable resistance value according to the rotation of the second spur gear 53e.

The control unit 20 detects a voltage level that changes according to the resistance value of the volume resistor 53f so as to sense the position of the knob 51a of the flow velocity control valve 51.

The compressed air supply source 70 supplies compressed air through the inlet 60, and any means can be used as the compressed air supply source 70 as long as the means can supply compressed air. For example, the compressed air supply source 70 may be an oxygen tank in which high-pressure oxygen is filled.

Hereinafter, the process of operating the controller for a cardiopulmonary resuscitation apparatus according to the preferred embodiment of the invention will be described. For reference, the direction of supplying air to move forward to the respective cylinders 149, 157, and 172 is referred to as “forward,” and the direction to supply air to move backward the cylinders 149, 157, and 172 is referred to as “backward.”

First, the pressure controllers 62 and 64 control the pressure of the compressed air that is supplied through the inlet 60 by the compressed air supply source 70, to introduce the compressed air into the flow path.

An operator lays a patient on the main body 110 such that the patient's chest is positioned under the pressure pad 170, and selects a constricting mode for constricting the chest band 118 by the key input unit 16 while the patient's chest is wound by the left and right chest bands 118a and 118b.

If the operator selects the constricting mode, the control unit 20 outputs a control signal, so that the solenoid valve 33 is driven to change the direction of air, and the compressed air in the flow path is supplied forward to the chest band constricting cylinder 157 through the solenoid valve 33.

The forwardly supplied compressed air moves forward to the chest band constricting cylinder 157, and the moving body 154 connected to the axle of the chest band constricting cylinder 157 moves along the guide member 156, thus, the pinion 155 toothed with the rack gear 152 of the moving body 154 rotates.

The power transmission unit 150 transmits a rotational force of the pinion 155 to the bobbins 140 and 142 so as to rotate the bobbins 140 and 142, such that the chest band 118 is wound around the bobbins 140 and 142, and the patient's chest is fastened by the surrounding chest band 118.

After a predetermined time passes from the time that the operator selects the constricting mode, the solenoid valve 35 is driven to change the direction of air by the control signal output from the control unit 20, and the compressed air in the flow path is supplied forward to the locking cylinder 149 through the solenoid valve 35.

The forwardly supplied compressed air moves forward to the chest band locking cylinder 149, the pinion 155 and the bobbins 140 and 142 connected to the pinion 155 are fixed to be kept from rotating, while the locker 189 that has moved forward together with the locking cylinder 149 is meshed with the locking ratchet 152 of the moving body 154. Because the bobbins 140 and 142 are kept from rotating, the chest band 118 is prevented from being loosened.

When the operator selects a cardiopulmonary resuscitation mode through the key input unit 16, the operator can select a sub-mode for performing chest pressure and artificial respiration for a predetermined period, or a sub-mode for stop providing chest pressure and performing only the artificial respiration for a predetermined period.

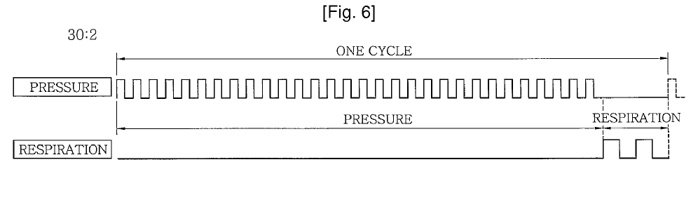

For example, as shown in FIG. 6, the operator can select a mode for performing cardiopulmonary resuscitation at the ratio 30:2 (two times of resuscitation per thirty times of chest pressure).

During the period for which chest pressure is repeatedly performed, the control unit 20 inputs a control signal for supplying compressed air forward to the pressure cylinder 172, and a control signal for supplying compressed air backward to the pressure cylinder 172, alternately, to the solenoid valve 36. During the period for which resuscitation is performed, the control unit 20 inputs a control signal for supplying compressed air to the breathing amount control unit 40 to the solenoid valve 31.

During the period for which chest pressure is repeatedly performed, in a section when chest pressure is repeatedly performed, the solenoid valve 36 changes its direction to supply compressed air to the pilot of the air pressure valve 37 according to a control signal output from the control unit 20. On the other hand, in a section where chest pressure is released, the solenoid valve 36 changes its direction to supply compressed air to the pilot of the air pressure valve 38 according to a control signal of the control unit 20.

In the section where the chest is pressed, the pilot of the air pressure valve 37 is operated by the compressed air supplied from the air solenoid valve 36 so as to open the air pressure valve 37, the compressed air in the flow path is supplied forward to the pressure cylinder 172 through the air pressure valve 37.

The forwardly supplied compressed air moves forward to the pressure cylinder 172, and the pressure pad 170 connected to the pressure cylinder 172 through the piston 114 descends so as to press the patient's chest.

Here, the pressed depth to which the pressure pad 170 descends can be changed according to the flow velocity of air that is controlled by the flow velocity control valve 51 of the pressed depth control unit 50. For example, when the flow velocity of the air passing through the flow velocity control valve 51 is controlled to increase, the velocity of the forward moving of the pressure cylinder 172 increases, and in the section where the chest is pressed, the length by which the pressure pad 170 moves increases, thereby increasing the pressed depth.

The operator can select a pressed depth with the key input unit 16, and the control unit allows the electric motor 52 of the control unit 50 to operate corresponding to the pressed depth selected by the operator with the key input unit 16, thereby turning the knob 51a of the flow velocity control valve 51.

When the electric motor 52 is operated to turn the knob 51a of the flow velocity control valve 51, the worm wheel 53c of the position sensor is meshed with the first spur gear 53d and the second spur gear 53e, whereby the resistance value of the volume resistor 53f changes.

The control unit 20 detects a voltage level according to the resistance value of the volume resistor 53f so as to sense the turned position of the knob 51a of the flow velocity control valve 51.

For reference, the position information that is sensed by the volume resistor 53f can be used as data for precisely controlling the electric motor 52 by the control unit 20, and utilized for calibrating the position of the knob 51a of the flow velocity control valve 51 when the cardiopulmonary resuscitation apparatus and the controller are manufactured and operated for the first time.

In the section where the chest pressure is released, the direction of the air of the solenoid valve 36 is changed such that the compressed air is supplied to the pilot of the air pressure valve 38; therefore, the air pressure valve 38 is opened while the air pressure valve 37 is closed, and the compressed air of the flow path is supplied backward to the pressure cylinder 172 through the air pressure valve 38.

The backwardly supplied compressed air moves the pressure cylinder 172 backwards to the initial position, and the pressure pad 170 connected to the pressure cylinder 172 by the piston 114 ascends, thus releasing the chest pressure.

As exemplified in FIG. 6, during the period for which chest pressure is performed thirty times and then artificial respiration is performed two times, in the section where compressed air is supplied for the artificial respiration, the solenoid valve 32 changes its direction to supply the compressed air to the breathing amount control unit 40 according to a control signal of the control unit 20, the compressed air in the flow path is supplied to the breathing amount control unit 40 through the solenoid valve 32.

During the period for which artificial respiration is performed two times, in the section when the compressed air for artificial respiration is blocked, the solenoid valve 32 changes its direction not to supply the compressed air to the breathing amount control unit 40 according to a control signal output from the control unit 20, thus stopping supplying the air to the breathing amount control unit 40.

For reference, when the operator selects the mode for performing only artificial respiration for the predetermined period, the control unit 20 does not output a control signal for performing chest pressure, but outputs a control signal for performing artificial respiration.

Although the present invention has been described in connection with the exemplary embodiment of the present invention, it will be apparent to those skilled in the art that the present invention is not limited to the embodiment, and various modifications and changes may be made thereto without departing from the scope and spirit of the invention, and the modifications and changes using the aspects of the present invention are included in the scope of the present invention.

In particular, according to the embodiment of the invention, only the solenoid valve is exemplified as the electric valve that operates according to a control signal of the control unit, but it is not limiting, but illustrative. Any known valve can be used in the present invention as long as it operates by an electrical signal.

1. A controller for a cardiopulmonary resuscitation apparatus, the cardiopulmonary resuscitation apparatus pressing the chest by piston motion of a pressure pad, the controller comprising:
a pressure cylinder for causing a piston motion to the pressure pad by compressed air;
a control unit for generating a control signal for operating the pressure cylinder; and
a valve means for supplying compressed air to the pressure cylinder by the control signal output from the control unit.

2. The controller for a cardiopulmonary resuscitation apparatus of claim 1, wherein the pressure cylinder is a double acting pneumatic cylinder using the force of compressed air input from forward and backward directions to move reciprocally; and
the valve means changes the direction of the compressed air to be supplied to the double acting pneumatic cylinder according to a control signal of the control unit.

3. The controller for a cardiopulmonary resuscitation apparatus of claim 2, wherein the valve means includes:
an electric valve operating according to a control signal of the control unit and changing the direction of compressed air so as to supply the compressed air;
a forward air pressure valve to be opened/closed by compressed air supplied by the electric valve in one direction and forwardly supplying the compressed air to the pressure cylinder when the air pressure valve is opened; and
a backward air pressure valve to be opened/closed by compressed air supplied by the electric valve in the other direction and backwardly supplying the compressed air to the pressure cylinder while the air pressure valve is opened.

4. The controller for a cardiopulmonary resuscitation apparatus of claim 2, further comprising:
a pressed depth control unit for controlling the flow velocity of compressed air that is forwardly supplied to the pressure cylinder according to a control signal of the control unit.

5. The controller for a cardiopulmonary resuscitation apparatus of claim 4, wherein the pressed depth control unit includes:
a flow velocity control valve for controlling the flow velocity of compressed air when a knob is turned; and
an electric motor for rotating according to a control signal of the control unit and turning the knob of the flow velocity control valve.

6. The controller for a cardiopulmonary resuscitation apparatus of claim 5, further comprising:
a position sensor for sensing the position of the knob of the flow velocity control valve and inputting a sensed value corresponding to the position to the control unit.

7. The controller for a cardiopulmonary resuscitation apparatus of claim 6, wherein the position sensor includes:
a bracket to which the electric motor is fixed;
a worm gear provided at a rotation axle of the electric motor;
an axle member rotatably disposed to the bracket;
a worm wheel fixed to the axle member and toothed with the worm gear;
a first spur gear fixed to the axle member;
a second spur gear toothed with the first spur gear; and
a volume resistor connected to the second spur gear.

8. The controller for a cardiopulmonary resuscitation apparatus of claim 1, further comprising:
an electric valve operating according to a control signal of the control unit and supplying compressed air to an artificial respiration equipment.

9. The controller for a cardiopulmonary resuscitation apparatus of claim 8, further comprising:
a breathing amount control unit controlling the amount of compressed air that is supplied to the artificial respiration.

10. The controller for a cardiopulmonary resuscitation apparatus of claim 1, further comprising:
a chest band for wrapping a patient's chest;
a bobbin for winding and unwinding the chest band;
a chest band constricting cylinder for performing a piston motion by compressed air;
a means for converting the piston motion of the chest band constricting cylinder into a rotation motion to rotate the bobbin; and
a valve means for supplying compressed air to the pressure cylinder according to a control signal of the control unit.

11. The controller for a cardiopulmonary resuscitation apparatus of claim 10, further comprising:
a locking cylinder performing a piston motion by compressed air;
a means for restricting and releasing the rotation of the bobbin according to the piston motion of the locking cylinder; and
a valve means for supplying compressed air to the locking cylinder according to a control signal of the control unit.
